(19) United States
(12) Patent Application Publication
(10) Pub. No.: US 2025/0074212 A1
(43) Pub. Date: Mar. 6, 2025

(54) ELECTRIC DRIVE DEVICE

(71) Applicant: DENSO CORPORATION, Kariya-city (JP)

(72) Inventors: YOSHINORI AKITSU, Kariya-city (JP); SHUJI KURAMITSU, Kariya-city (JP); KIYOSHI FUJII, Kariya-city (JP)

(21) Appl. No.: 18/949,493

(22) Filed: Nov. 15, 2024

Related U.S. Application Data
(63) Continuation of application No. PCT/JP2023/017134, filed on May 2, 2023.

(30) Foreign Application Priority Data
May 19, 2022 (JP) 2022-082381

(51) Int. Cl. B60L 15/22; B60L 50/60; B60R 16/023

(52) U.S. Cl. CPC B60L 15/22; B60L 50/60; B60R 16/0232; B60L 2200/24; B60L 2200/40; B60L 2210/40; B60L 2240/423; B60L 2240/526

(57) ABSTRACT

An electric drive device for driving a vehicle includes a drive unit for rotating drive wheels of the vehicle. The drive unit includes a plurality of system devices, a rotor that constitutes a motor and is common to each system device, and a housing that is long in a tubular shape in a direction in which a rotor shaft extends and that houses each system device and the rotor in a tubular space. Each system device has a stator winding that constitutes a motor, and an inverter electrically connected to the stator winding. The drive unit has a control unit that performs a switching control of each inverter to rotate the rotor and thereby rotate the drive wheels.

### CROSS REFERENCE TO RELATED APPLICATIONS

This application is a continuation application of International Patent Application No. PCT/JP2023/017134 filed on May 2, 2023, which designated the U.S. and based on and claims the benefits of priority of Japanese Patent Application No. 2022-082381 filed on May 19, 2022. The entire disclosure of all of the above applications is incorporated herein by reference.

### TECHNICAL FIELD

The present disclosure relates to an electric drive device.

### BACKGROUND

Conventionally, an electric drive device for propelling vehicle is known.

### SUMMARY

An object of the present disclosure is to provide an electric drive device that can keep a vehicle driving as long as possible.

The present disclosure relates to an electric drive device for driving a vehicle.

The electric drive device includes a drive unit for rotating drive wheels of the vehicle.

The drive unit has a plurality of system devices, a rotor that constitutes a motor and is common to each of the system devices, and a housing having a tubular shape elongated in a direction in which the shaft of the rotor extends, the housing accommodating the system devices and the rotor in a tubular space.

Each of the system devices has a stator winding constituting the motor, and an inverter electrically connected to the stator winding.

The drive unit has a control unit that performs switching control of the inverters to rotate the rotor and thereby rotate the drive wheels.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an overall configuration diagram of an automated guided vehicle according to a first embodiment;

FIG. 2 shows a drive unit;

FIG. 3 is a diagram showing an internal structure of a motor;

FIG. 4 is a cross-sectional view taken along a line IV-IV of FIG. 3, showing a motor portion;

FIG. 5 is a diagram showing an electrical configuration of a drive unit;

FIG. 6 is a flowchart showing a processing procedure for driving control of an automated guided vehicle;

FIG. 7 is a diagram showing an example of fail-safe control when an abnormality occurs;

FIG. 8 is a flowchart showing a processing procedure for driving control of an automated guided vehicle according to a second embodiment;

FIG. 9 is a diagram showing an example of fail-safe control when an abnormality occurs;

FIG. 10 is a flowchart showing a processing procedure for driving control of an automated guided vehicle according to a third embodiment;

FIG. 11 is a diagram showing the overall configuration of an electric wheelchair according to a fourth embodiment;

FIG. 12 is an overall configuration diagram of a senior car according to a fifth embodiment; and

FIG. 13 is a diagram showing an electrical configuration of a drive unit according to another embodiment.

### DETAILED DESCRIPTION

In assumable example, an electric drive device for propelling vehicle is known. The electric drive device is applied to an automated guided vehicle used in a factory.

The electric drive device includes a motor having a rotor and a stator winding, an inverter electrically connected to the stator winding, and a control unit that performs switching control of the inverter. When the control unit performs switching control of the inverter, the rotor rotates, and the rotational power of the rotor is transmitted to the drive wheels. Accordingly, the vehicle drives.

Here, when an abnormality occurs in the inverter or the stator winding, there is a concern that the vehicle may not be able to continue driving.

An object of the present disclosure is to provide an electric drive device that can keep a vehicle driving as long as possible.

The present disclosure relates to an electric drive device for driving a vehicle.

The electric drive device includes a drive unit for rotating drive wheels of the vehicle.

The drive unit has a plurality of system devices, a rotor that constitutes a motor and is common to each of the system devices, and a housing having a tubular shape elongated in a direction in which the shaft of the rotor extends, the housing accommodating the system devices and the rotor in a tubular space.

Each of the system devices has a stator winding constituting the motor, and an inverter electrically connected to the stator winding.

The drive unit has a control unit that performs switching control of the inverters to rotate the rotor and thereby rotate the drive wheels.

The drive unit of the present disclosure includes a plurality of system devices and a rotor common to each of the system devices. Each system device includes a stator winding and an inverter. Therefore, even if an abnormality occurs in the inverter or stator winding of any of the system devices, the rotor can be rotated and the drive wheels can be rotated by switching control of the inverter of the system device that is not experiencing an abnormality. This allows the vehicle to continue driving as long as possible.

In the present disclosure, each system device and the rotor are housed in the tubular space of the housing. For this reason, the wiring that electrically connects the stator windings and the inverter is also accommodated in the housing. Therefore, in a configuration in which a plurality of system devices each having the stator winding and the inverter are provided, the layout of wiring can be simplified.

### First Embodiment

Hereinafter, a first embodiment embodying an electric drive device according to the present disclosure will be described with reference to the drawings. The electric drive device is applied to small mobility. The small mobility of the present embodiment is a vehicle that drives at a low speed, for example, 10 km/h or less, and specifically, is an automated guided vehicle (AGV) that is an electric vehicle used in factories.

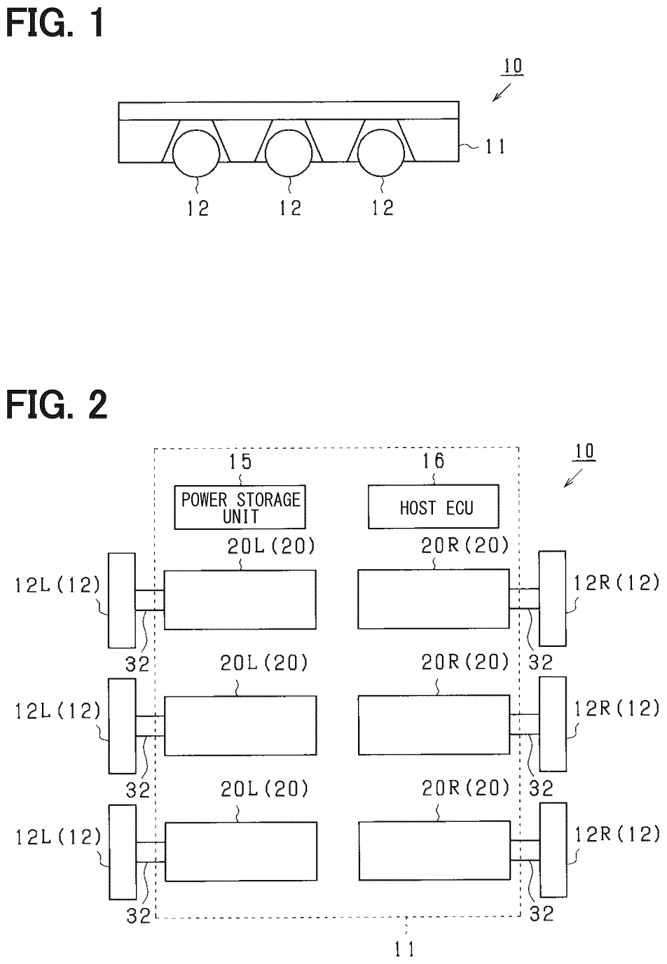

As shown in FIGS. 1 and 2, the automated guided vehicle 10 includes a vehicle body 11 and a plurality of drive wheels 12. In the present embodiment, the plurality of drive wheels 12 include a right drive wheel 12R and a left drive wheel 12L that is aligned with the right drive wheel 12R in a vehicle width direction. The automated guided vehicle 10 is equipped with three pairs of right drive wheels 12R and left drive wheels 12L.

The vehicle body 11 is equipped with an electric drive device for driving the automated guided vehicle 10, a power storage unit 15, and a host ECU 16. The power storage unit 15 is, for example, a secondary battery such as a lithium ion battery. In the present embodiment, the power storage unit 15 is divided into a first power storage unit 15A and a second power storage unit 15B in order to provide redundancy in the configuration.

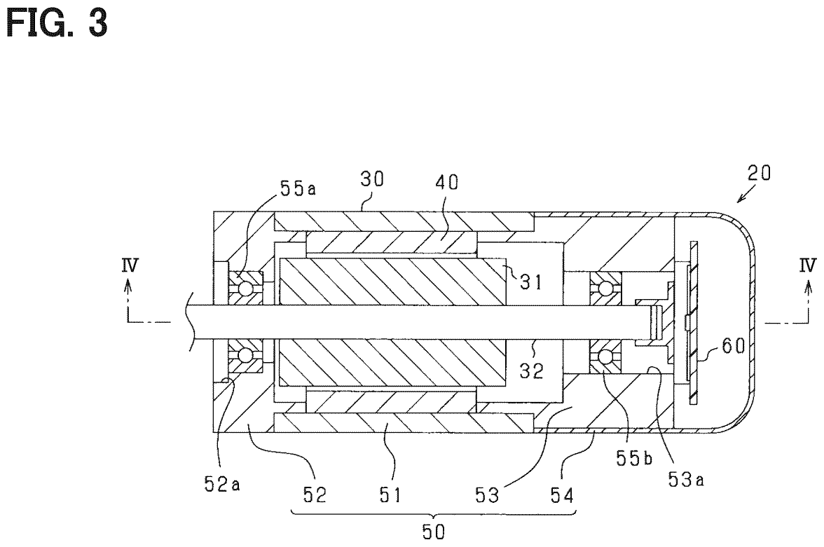

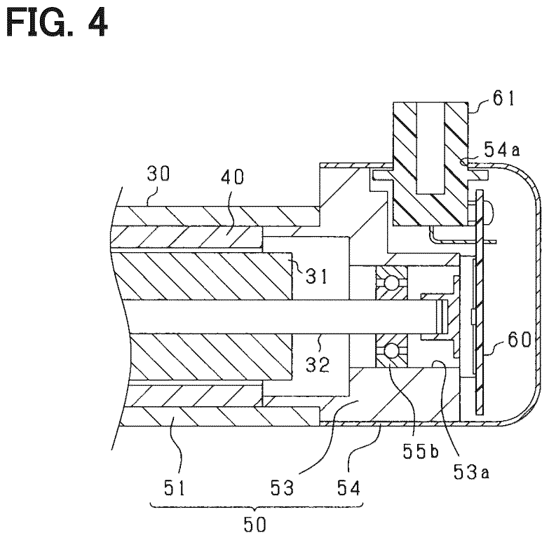

The electric drive device includes a drive unit 20 corresponding to each drive wheel 12. In the present embodiment, each of the drive units 20 basically have the same configuration. The drive unit 20 has a motor 30. The motor 30 will be described below with reference to FIGS. 3 and 4. FIG. 4 is a cross-sectional view taken along line IV-IV of FIG. 3.

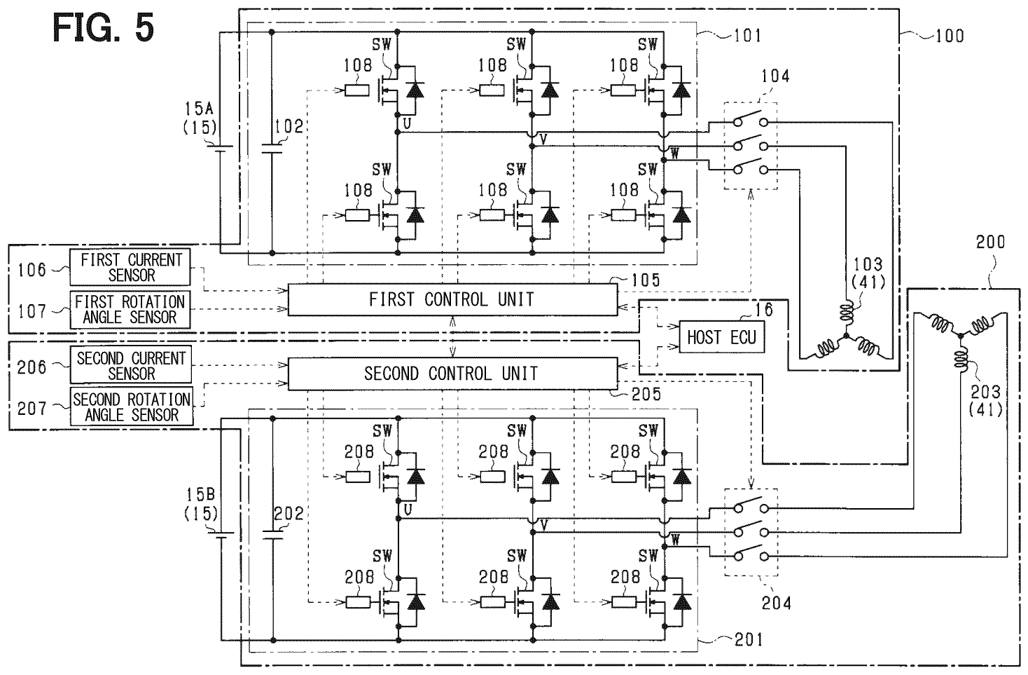

The motor 30 includes a rotor 31 having field poles (e.g., permanent magnets), a shaft 32 fixed to the rotor 31, and a stator 40 disposed radially outwardly facing the rotor 31. The stator 40 includes a stator core and a stator winding 41 (see FIG. 5) wound around the stator core.

The motor 30 includes a housing 50. The housing 50 has a tubular portion 51, a wheel side cover portion 52, a connection portion 53 and a vehicle body side cover portion 54. The tubular portion 51 has a long tubular shape extending in a direction in which the shaft 32 extends, and more specifically, has a cylindrical shape. The wheel side cover portion 52 is provided on a first end of the tubular portion 51 in the longitudinal direction, and the connection portion 53 is provided on a second end thereof. The rotor 31 and the stator 40 are housed in a tubular (cylindrical) space surrounded by the tubular portion 51, the wheel side cover portion 52, and the connection portion 53. The stator 40 is provided on an inner circumferential surface of the tubular portion 51. The cross section of the housing 50 is not limited to being cylindrical, but may be, for example, rectangular.

The wheel side cover portion 52 is formed with a wheel side opening 52a, and a first bearing 55a is provided in the wheel side opening 52a. The connecting portion 53 is formed with a vehicle body side opening 53a, and a second bearing 55b is provided in the vehicle body side opening 53a. In the present embodiment, each of the bearings 55a, 55b is a rolling bearing having an inner ring, an outer ring, and rolling elements (eg, rollers). A first end side of the shaft 32 is rotatably supported by the first bearing 55a, and a second end side of the shaft 32 is rotatably supported by the second bearing 55b. The drive wheel 12 is connected to a first end of the shaft 32. The shaft 32 functions as a drive shaft that drives the drive wheel 12 to rotate.

The vehicle body side cover portion 54 is provided on the connecting portion 53 on the opposite side to the tubular portion 51 in the longitudinal direction of the housing 50. A control board 60 is disposed in the space surrounded by the connection portion 53 and the vehicle body side cover portion 54. In the present embodiment, the control board 60 is disposed so that a plate surface of the control board 60 is perpendicular to the direction in which the shaft 32 extends. The vehicle body side cover portion 54 has a connector opening portion 54a formed therein. A connector 61 electrically connected to the control board 60 is inserted into the connector opening portion 54a. The connector 61 includes a power connector and a communication connector.

As described above, in the present embodiment, the housing 50 accommodates the rotor 31, the stator 40, and the control board 60 on which an inverter, which will be described later, and the like are mounted. Therefore, the wiring electrically connecting the stator windings 41 and the inverter can also be accommodated in the housing 50, simplifying the configuration of the electric drive device.

In addition, the first end of the shaft 32 and the drive wheel 12 may be connected via a reduction device. The reduction device is, for example, a reduction gear including a planetary gear mechanism or a cycloid gear mechanism, and increases the output torque of the motor 30 and outputs it to the drive wheels 12. In this case, the reduction device may also be accommodated in the housing 50.

Next, the electrical configuration of each drive unit 20 will be described with reference to FIG. 5.

The motor 30 included in each drive unit 20 is provided with two systems of stator windings 41 for one rotor 31. An inverter, a control unit, and various sensors are provided for each of the stator windings 41 of each system. As a result, even if an abnormality occurs in one of the systems, the torque output of the motor 30 can be continued by the remaining system. Each drive unit 20 includes a first system device 100 having a first stator winding 103 which is a stator winding 41 of a first system, and a second system device 200 having a second stator winding 203 which is a stator winding 41 of a second system. The first system device 100 and the second system device 200 are accommodated in a housing 50.

The first system device 100 includes a first inverter 101. The first inverter 101 includes upper and lower arm switches SW for three phases. In the present embodiment, the switch SW is a voltage-controlled semiconductor switching element, and more specifically, is a SiC N-channel MOSFET. Therefore, in the switch SW, the high potential terminal is a drain, and the low potential terminal is a source. The switch SW has a body diode. The switch SW may be, for example, an IGBT. In this case, in the switch SW, the high potential terminal is a collector and the low potential terminal is an emitter.

In each phase, a first end of a first smoothing capacitor 102 is connected to the drain of the upper arm switch SW. In each phase, the drain of the lower arm switch SW is connected to the source of the upper arm switch SW. In each phase, a second end of the first smoothing capacitor 102 is connected to the source of the lower arm switch SW. In each phase, a first end of the first stator winding 103 is connected to the source of the upper arm switch SW and the drain of the lower arm switch SW. The second ends of the first stator windings 103 of each phase are connected at the neutral point.

A positive terminal of a first power storage unit 15A constituting the power storage unit 15 is connected to a first end of the first smoothing capacitor 102 via a power connector included in the connector 61 and a power cable (not shown). A negative terminal of first power storage unit 15A is connected to a second end of first smoothing capacitor 102 via a power connector and a power cable (not shown).

The first system device 100 includes a first cutoff switch 104 that connects the first inverter 101 and the first stator winding 103. The first cutoff switches 104 are provided individually corresponding to each phase. The first cutoff switch 104 is, for example, a normally open type semiconductor switch or a mechanical relay.

The first system device 100 includes a first control unit 105, a first current sensor 106, a first rotation angle sensor 107, and a first drive IC 108. In the present embodiment, the first drive IC 108 is provided individually corresponding to each switch SW. The first current sensor 106 detects the current (phase current) flowing through the first stator winding 103. The first rotation angle sensor 107 detects a rotation angle position (electrical angle) of the rotor 31. The detection values of the first current sensor 106 and the first rotation angle sensor 107 are input to the first control unit 105.

The first control unit 105 is mainly constituted by a microcomputer. The first control unit 105 performs switching control of each switch SW that constitutes the first inverter 101 to control the control amount of the motor 30 corresponding to the first stator winding 103 to a first command value based on each detection value. In the present embodiment, the controlled variable is torque, so the first command value is a first command torque.

In detail, the first control unit 105 generates drive signals corresponding to the upper and lower arm switches SW so as to alternately turn on the upper arm switch SW and the lower arm switch SW in each phase. The first control unit 105 outputs the generated drive signal to the first drive IC 108. The first control unit 105, the first drive IC 108, the first inverter 101 and the first smoothing capacitor 102 are provided on the control board 60 accommodated in the housing 50.

Similar to the first system device 100, the second system device 200 includes a second inverter 201, a second smoothing capacitor 202, a second stator winding 203, a second cutoff switch 204, a second control unit 205, a second current sensor 206, a second rotation angle sensor 207, and a second drive IC 208. The configuration of the second system device 200 is basically the same as the configuration of the first system device 100. Therefore, hereinafter, detailed description of the second system device 200 will be omitted as appropriate.

A second power storage unit 15B constituting the power storage unit 15 is connected to the second inverter 201.

The second control unit 205 is mainly constituted by a microcomputer. The second control unit 205 performs switching control of each switch SW constituting the second inverter 201 to control the torque of the motor 30 corresponding to the second stator winding 203 to a second command torque based on each detection value. The output torque of the motor 30 is controlled to the sum of the first command torque and the second command torque.

In detail, the second control unit 205 generates drive signals corresponding to the upper and lower arm switches SW so as to alternately turn on the upper arm switch SW and the lower arm switch SW in each phase. The second control unit 205 outputs the generated drive signal to the second drive IC 208. The second control unit 205, the second drive IC 208, the second inverter 201 and the second smoothing capacitor 202 are provided on the control board 60.

The switching frequencies of the second inverter 201 and the first inverter 101 are set to frequencies higher than the human audible range. This ensures current controllability while reducing NV.

The first control unit 105 and the second control unit 205 are configured to be able to communicate with each other. Therefore, for example, the detection values of the current sensors 106 and 206 and the rotation angle sensors 107 and 207 can be exchanged between the control units 105 and 205.

Even if an abnormality occurs in either the first system device 100 or the second system device 200, the driving control of the automated guided vehicle 10 can be continued by the system device where no abnormality is occurring.

Each of the control units 105 and 205 communicates with the host ECU 16 via a communication connector that constitutes the connector 61. The host ECU 16 transmits command torques to the control units 105, 205 of each drive unit 20 via the communication connector so as to realize desired control, such as driving control of the automated guided vehicle 10. In the following, of the drive units 20, the drive unit that rotates the right drive wheel 12R may be referred to as a right unit 20R, and the drive unit that rotates the left drive wheel 12L may be referred to as a left unit 20L.

A normal control for performing straight-line driving, turning and braking of the automated guided vehicle 10 will be described.

When the host ECU 16 determines that the automated guided vehicle 10 has been instructed to drive straight ahead, the host ECU 16 transmits a command torque to each right unit 20R and each left unit 20L so that each right drive wheel 12R and each left drive wheel 12L rotate in the same direction and so that the rotational speed of each right drive wheel 12R and each left drive wheel 12L are the same. In each unit 20R, 20L, the first control unit 105 calculates half of the received command torque as the first command torque, and performs switching control of the first inverter 101 so that the torque corresponding to the first stator winding 103 becomes the first command torque. In each unit 20R, 20L, the second control unit 205 calculates half of the received command torque as the second command torque, and performs switching control of the second inverter 201 so that the torque corresponding to the second stator winding 203 becomes the second command torque.

When the host ECU 16 determines that the automated guided vehicle 10 has been instructed to turn right, the host ECU 16 transmits a command torque to each right unit 20R and each left unit 20L so that each right drive wheel 12R and each left drive wheel 12L rotate in the same direction and so that the rotational speed of each right drive wheel 12R, which corresponds to the inner wheel, is lower than the rotational speed of each left drive wheel 12L, which corresponds to the outer wheel.

When the host ECU 16 determines that the automated guided vehicle 10 has been instructed to turn left, the host ECU 16 transmits a command torque to each right unit 20R and each left unit 20L so that each right drive wheel 12R and each left drive wheel 12L rotate in the same direction and so that the rotational speed of each left drive wheel 12L, which corresponds to the inner wheel, is lower than the rotational speed of each right drive wheel 12R, which corresponds to the outer wheel.

In addition, the host ECU 16 can also transmit a command torque to each of the right units 20R and each of the left units 20L so as to rotate each of the right drive wheels 12R and each of the left drive wheels 12L in opposite directions. In this case, the automated guided vehicle 10 makes a extra-pivot turn.

When the host ECU 16 determines that braking of the automated guided vehicle 10 has been instructed, the host ECU 16 transmits a command torque to each right unit 20R and each left unit 20L so as to cause the motor 30 of each drive unit 20 to generate a braking torque. As a result, a braking force is applied to each drive wheel 12 of the automated guided vehicle 10, and the automated guided vehicle 10 then stops.

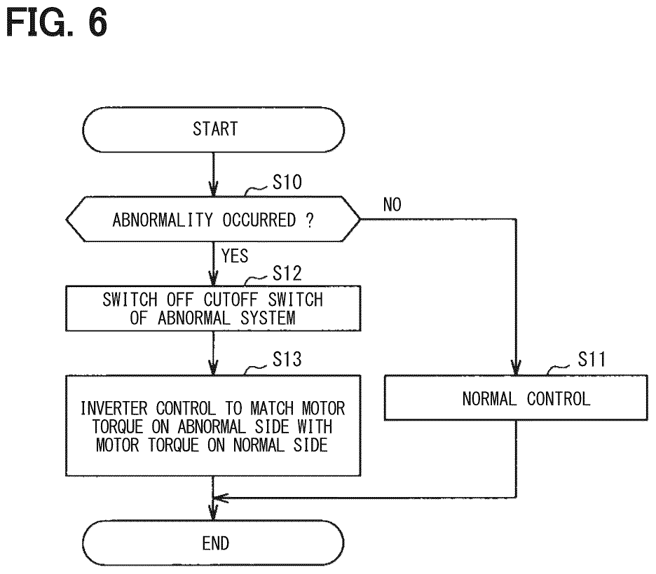

In addition, the first control unit 105, the second control unit 205 and the host ECU 16 are equipped with a microcomputer, and the functions provided by each microcomputer can be provided by software recorded in a physical memory device and a computer that executes the software, by software only, by hardware only, or a combination of these. For instance, suppose that the microcomputer be provided by including or using a hardware circuit serving as an electronic circuit. Such an electronic circuit may be provided by including analog circuitry and/or digital circuitry including multiple logic circuits. For example, the microcomputer executes a program stored in a non-transitory tangible storage medium serving as a storage unit included therein. The programs include, for example, a driving control processing program shown in FIG. 6. With the execution of the program, a method corresponding to the program is executed. The storage unit is, for example, a non-volatile memory. The programs stored in the storage unit can be updated via a network such as the Internet, for example, over the air (OTA).

In each drive unit 20, an abnormality may occur in either the first system device 100 or the second system device 200. Even in this case, in the present embodiment, fail-safe control is executed so that the automated guided vehicle 10 can continue driving as much as possible. This will prevent factory production lines from having to stop.

The process of the driving control of the automated guided vehicle 10, including the above-mentioned fail-safe control, will be described with reference to FIG. 6. The processing shown in FIG. 6 is executed by the host ECU 60.

In step S10, it is determined in each drive unit 20 whether an abnormality has occurred in either the first system device 100 or the second system device 200. In detail, in each drive unit 20, when it is determined that an abnormality has occurred in at least one of the first inverter 101, the first cutoff switch 104, the first stator winding 103, the first control unit 105, the first current sensor 106, and the first rotation angle sensor 107, it is determined that an abnormality has occurred in the first system device 100. In addition, in each drive unit 20, when it is determined that an abnormality has occurred in at least one of the second inverter 201, the second cutoff switch 204, the second stator winding 203, the second control unit 205, the second current sensor 206, and the second rotation angle sensor 207, it is determined that an abnormality has occurred in the second system device 200. The abnormality of the inverters 101 and 201 includes, for example, at least one of an open failure and a short failure of the switch SW. The abnormality of the stator windings 103, 203 includes, for example, at least one of a disconnection failure and an inter-phase short circuit failure of the stator windings.

When it is determined in step S10 that no abnormality has occurred in either the first system device 100 or the second system device 200, the process proceeds to step S11, and the above-mentioned normal control such as straight driving or cornering is performed.

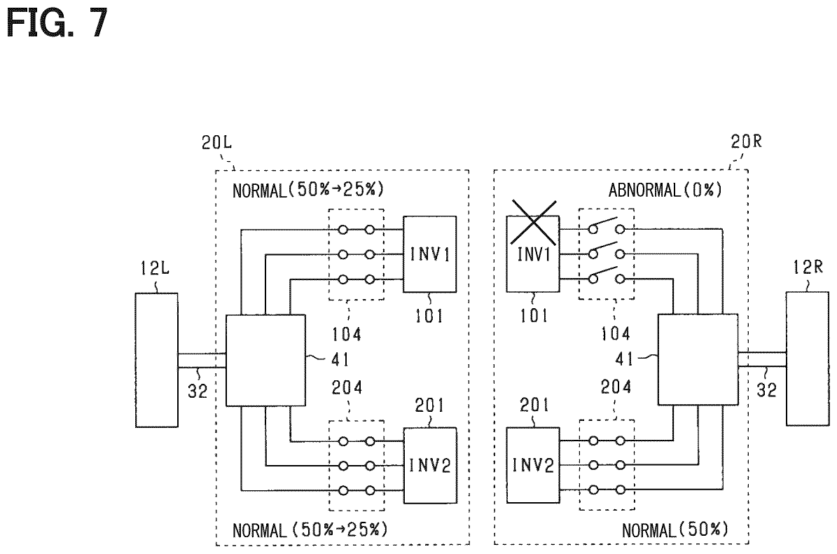

A case where it is determined in step S10 that an abnormality has occurred in either the first or second system device 100, 200 constituting the right unit 20R will be described. In this case, the process proceeds to step S12, and in the right unit 20R in which an abnormality has occurred among the drive units 20, a command is sent to switch off the cutoff switch of the system device in which the abnormality has occurred among the first and second system devices 100, 200. For example, as shown in FIG. 7, when an abnormality occurs in the first inverter 101 of the first system device 100 of a certain right unit 20R, a command to switch off the first cutoff switches 104 for three phases is transmitted. The transmitted command is received by at least one of the first and second control units 105, 205 of the right unit 20R in which the abnormality has occurred. When at least one of the first and second control units 105 and 205 receives the command, it switches off the corresponding cutoff switch.

When the automated guided vehicle 10 continues to drive, unless the cutoff switch has a short circuit failure, the regenerative current is prevented from flowing to the stator winding, inverter, and smoothing capacitor of the system device in which the abnormality has occurred. As a result, the generation of regenerative torque is prevented, and adverse effects on the driving control of the automated guided vehicle 10 during fail-safe control are prevented.

When the cutoff switch is turned on, even if shutdown control is being performed to turn off each switch SW of the inverter, if the back electromotive force generated in the stator winding due to the rotation of the rotor 31 exceeds the terminal voltage of the smoothing capacitor, the regenerative current flows and a regenerative torque is generated. The regenerative torque has a negative effect on the driving control of the automated guided vehicle 10.

In step S13, a shutdown command for turning off each switch SW of the inverter included in the system device in which the abnormality has occurred, out of the first and second system devices 100, 200, is transmitted to the right unit in which the abnormality has occurred, out of the right unit 20R. The transmitted command is received by at least one of the first and second control units 105, 205 of the right unit 20R in which the abnormality has occurred. When at least one of the first and second control units 105 and 205 receives the command, it performs shutdown control of the corresponding inverter.

In step S13, in each of the left units 20L, in the left unit that is aligned in the vehicle width direction with the right unit 20R in which an abnormality has occurred (hereinafter, the target left unit), a switching control is performed on the first and second inverters 101, 201 of the target left unit so as to reduce the output torque of the motor 30 to the output torque of the motor 30 of the right unit 20R in which an abnormality has occurred. This allows the automated guided vehicle 10 to continue driving straight ahead while maintaining the stability of the automated guided vehicle 10's straight ahead driving as much as possible.

FIG. 7 shows a case in which, in the right unit 20R where an abnormality has occurred, the switching control of the first inverter 101 is stopped, the output torque corresponding to the first stator winding 103 becomes zero, and the output torque of the motor 30 becomes half of the command torque transmitted from the host ECU 16. In this case, the first and second control units 105, 205 of the target left unit perform switching control of the first and second inverters 101, 201 of the target left unit so as to reduce the output torque of the motor 30 of the target left unit to the output torque of the motor 30 of the right unit 20R in which the abnormality has occurred. In the example shown in FIG. 7, in the target left unit, the output torque corresponding to the first stator winding 103 is reduced to ½ to ¼ of the command torque transmitted from the host ECU 16, and the output torque corresponding to the second stator winding 203 is reduced to ½ to ¼ of the command torque transmitted from the host ECU 16. However, the output torques after reduction corresponding to the stator windings 103 and 203 are not limited to being the same, and may be different.

Next, a case where it is determined in step S10 that an abnormality has occurred in either the first or second system device 100, 200 constituting the left unit 20L will be described. In this case, the process proceeds to step S12, and in the left unit 20L in which an abnormality has occurred among the drive units 20, a command is sent to switch off the cutoff switch of the system device in which the abnormality has occurred among the first and second system devices 100, 200.

In step S13, a shutdown command for turning off each switch SW of the inverter included in the system device in which the abnormality has occurred, out of the first and second system devices 100, 200, is transmitted to the left unit in which the abnormality has occurred, out of the left unit 20L.

Furthermore, in step S13, in each of the right units 20R, in the right unit that is aligned in the vehicle width direction with the left unit 20L in which an abnormality has occurred (hereinafter, the target left unit), a switching control is performed on the first and second inverters 101, 201 of the target left unit so as to reduce the output torque of the motor 30 to the output torque of the motor 30 of the left unit 20L in which an abnormality has occurred.

When the automated guided vehicle 10 is caused to turn, in step S13, the turning control described in the normal control is performed by making the output torque of the motor of each drive unit 20 other than the drive unit in which an abnormality has occurred less than or equal to the outputtable torque of the motor 30 of the drive unit in which an abnormality has occurred.

According to the present embodiment described above in detail, even if an abnormality occurs in either the first system device 100 or the second system device 200 in each drive unit 20 of the automated guided vehicle 10, the automated guided vehicle 10 can continue to run as much as possible.

### Modification of First Embodiment

The automated guided vehicles used in factories are not limited to AGVs, and may be, for example, autonomous mobile robots (AMRs).

The host ECU 16 may transmit a command rotation speed of the rotor 31 to each of the right unit 20R and each of the left unit 20L, instead of the command torque.

### Second Embodiment

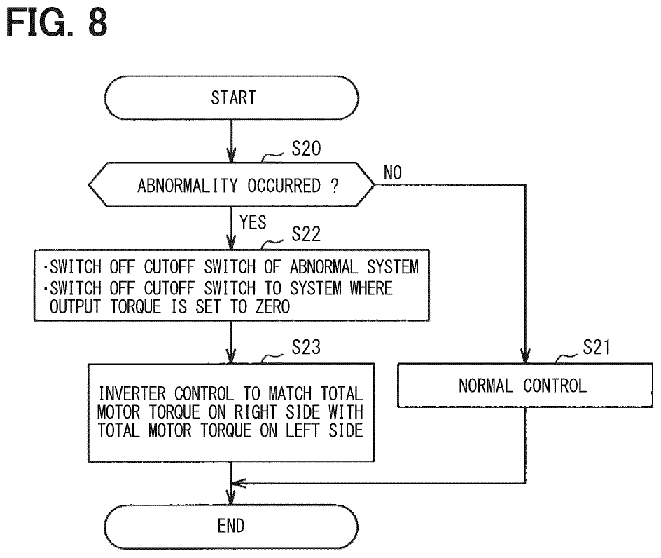

Hereinafter, a second embodiment will be described with reference to the drawings, focusing on differences from the first embodiment. In the present embodiment, when an abnormality occurs in either the first system device 100 or the second system device 200 in each drive unit 20, the total output torque of the motors 30 in each right unit 20R and the total output torque of the motors 30 in each left unit 20L are matched to allow the automated guided vehicle 10 to continue driving straight ahead. Hereinafter, the processing procedure of the driving control of the automated guided vehicle 10, including the above-mentioned fail-safe control, will be described with reference to FIG. 8. The processing shown in FIG. 8 is executed by the host ECU 16.

In step S20, similarly to step S10 in FIG. 6, it is determined in each drive unit 20 whether an abnormality has occurred in either the first system device 100 or the second system device 200.

When it is determined in step S20 that no abnormality has occurred in either the first system device 100 or the second system device 200, the process proceeds to step S21, and the above-mentioned normal control such as straight driving or cornering is performed, similar to step S11 in FIG. 6.

A case where it is determined in step S20 that an abnormality has occurred in either the first or second system device 100, 200 constituting the right unit 20R will be described. In this case, the process proceeds to step S22, and in the right unit 20R in which an abnormality has occurred among the drive units 20, a command is sent to switch off the cutoff switch of the system device in which the abnormality has occurred among the first and second system devices 100, 200, similar to step S12 in FIG. 6.

Furthermore, from among the drive units 20 in which no abnormality is occurring, in step S23 described later, a drive unit having a system device that sets the output torque to zero (hereinafter, referred to as a zero torque system device) is selected. Then, a command is transmitted to switch off the cutoff switch of the system device that has the output torque set to zero, out of the first and second system devices 100, 200 of the selected drive unit. As a result, the generation of regenerative torque is prevented, and adverse effects on the driving control of the automated guided vehicle 10 during fail-safe control are prevented.

In step S23, a shutdown command for turning off each switch SW of the inverter included in the system device in which the abnormality has occurred, out of the first and second system devices 100, 200, is transmitted to the right unit in which the abnormality has occurred, out of the right unit 20R. Also, a shutdown command is transmitted to turn off each switch SW of the inverter included in the zero torque power supply unit.

In step S23, a switching control is performed on the inverters of the first and second system devices 100, 200 of each drive unit 20 other than the system device in which it is determined that an abnormality has occurred and the zero torque system device, so as to reduce the total output torque of the motors 30 of each left unit 20L to the total output torque of the motors 30 of each right unit 20R that is not experiencing an abnormality. This allows the automated guided vehicle 10 to continue driving straight ahead while maintaining the stability of the automated guided vehicle 10's straight ahead driving as much as possible.

Next, a case where it is determined in step S20 that an abnormality has occurred in either the first or second system device 100, 200 constituting the left unit 20L will be described. In this case, the process proceeds to step S22, and in the left unit 20L in which an abnormality has occurred among the drive units 20, a command is sent to switch off the cutoff switch of the system device in which the abnormality has occurred among the first and second system devices 100, 200, similar to step S12 in FIG. 6.

Further, from among the drive units 20 in which no abnormality is occurring, a drive unit having the zero torque system device is selected. Then, a command is transmitted to switch off the cutoff switch of the system device that has the output torque set to zero, out of the first and second system devices 100, 200 of the selected drive unit.

In step S23, a shutdown command for turning off each switch SW of the inverter included in the system device in which the abnormality has occurred, out of the first and second system devices 100, 200, is transmitted to the left unit in which the abnormality has occurred, out of the left unit 20L. Also, a shutdown command is transmitted to turn off each switch SW of the inverter included in the zero torque power supply unit.

In step S23, a switching control is performed on the inverters of the first and second system devices 100, 200 of each drive unit 20 other than the system device in which it is determined that an abnormality has occurred and the zero torque system device, so as to reduce the total output torque of the motors 30 of each right unit 20R to the total output torque of the motors 30 of each left unit 20L that is not experiencing an abnormality.

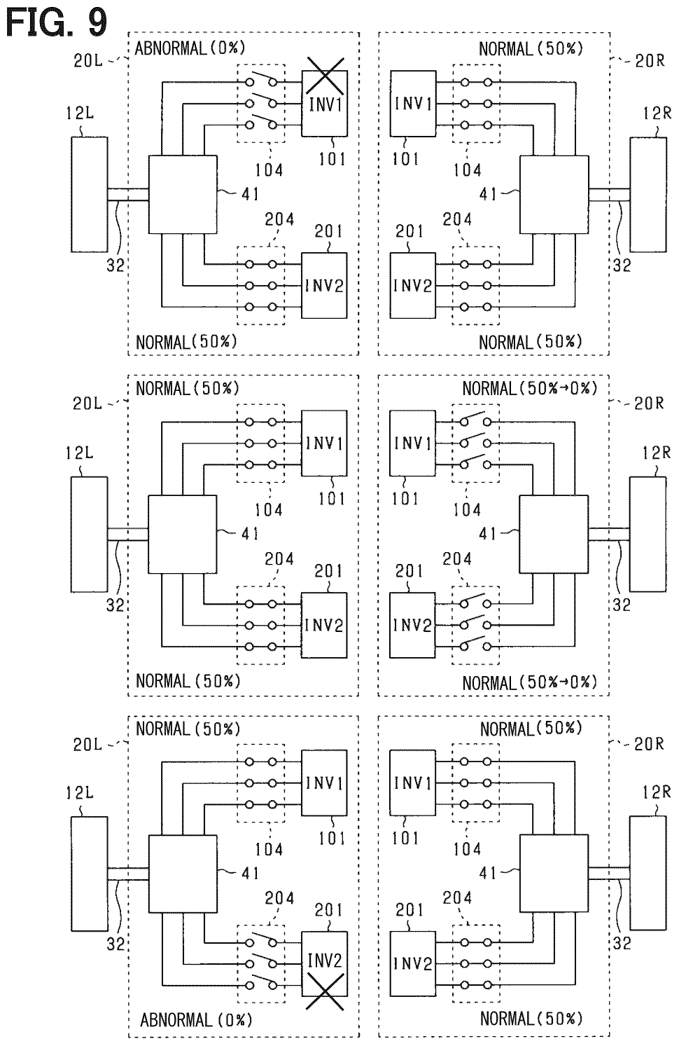

FIG. 9 shows an example in which an abnormality occurs in a first inverter 101 in the first left unit and the second inverter 201 in a third left unit among the three left units 20L. In this case, the first cutoff switch 104 of the first left unit 20L and the second cutoff switch 204 of the third left unit 20L are switched off.

In the example shown in FIG. 9, the first and second system devices 100, 200 included in the second right unit of the three right units 20R are selected as the zero torque system devices. As a result, the output torque of the motor 30 in the second right unit is set to zero.

When the total output torque of the left and right motors is the same, a zero torque system device is not necessary.

According to the present embodiment described above, the automated guided vehicle 10 can continue to drive.

### Third Embodiment

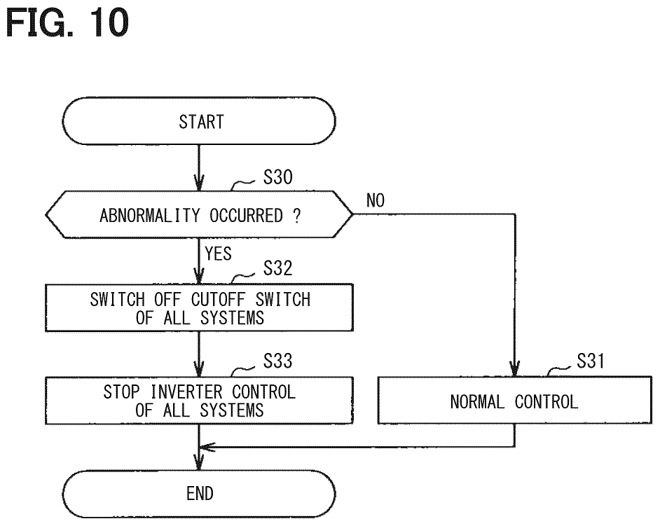

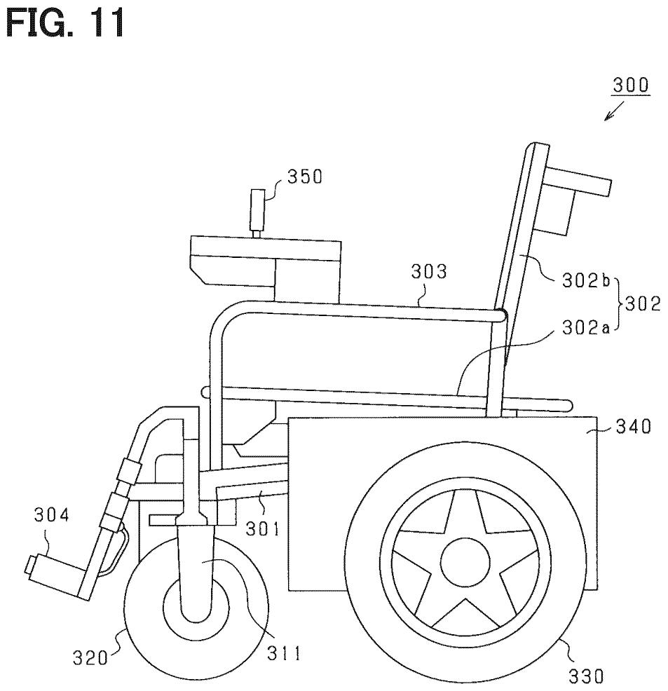

Hereinafter, the third embodiment will be described with reference to the drawings, focusing on the differences from the above-described embodiments. In the present embodiment, when an abnormality occurs in either the first or second system device 100, 200 of each drive unit 20, all of the first and second cutoff switches 104, 204 of each drive unit 20 are switched off. Hereinafter, the processing procedure of the driving control of the automated guided vehicle 10, including the above-mentioned fail-safe control, will be described with reference to FIG. 10. The processing shown in FIG. 10 is executed by the host ECU 16.

In step S30, similarly to step S10 in FIG. 6, it is determined in each drive unit 20 whether an abnormality has occurred in either the first system device 100 or the second system device 200.

When it is determined in step S30 that no abnormality has occurred in either the first system device 100 or the second system device 200, the process proceeds to step S31, and the above-mentioned normal control such as straight driving or cornering is performed, similar to step S11 in FIG. 6.

When it is determined in step S30 that an abnormality has occurred, the process proceeds to step S32, and a command is sent to switch off all of the first and second cutoff switches 104, 204 of each drive unit 20. As a result, all of the first and second cutoff switches 104, 204 of each drive unit 20 are switched off.

In step S33, a shutdown command is transmitted to all of the first and second inverters 101, 201 of each drive unit 20. As a result, the switching control of all of the first and second inverters 101, 201 of each drive unit 20 is stopped.

When an abnormality occurs in the automated guided vehicle 10, an operator may want to push the automated guided vehicle 10 by hand to move it. In this case, the rotor 31 of the motor 30 rotates, and a back electromotive force is generated in the stator winding 41. According to the present embodiment, it is possible to prevent the generation of regenerative torque caused by the back electromotive voltage. This reduces the load on the worker when moving the automated guided vehicle 10.

### Fourth Embodiment

Hereinafter, the fourth embodiment will be described with reference to the drawings, focusing on the differences from the above-described embodiments. In the present embodiment, as shown in FIG. 11, the small mobility is an electric wheelchair 300 as a small electric vehicle.

The electric wheelchair 300 includes a body frame 301 and a seat 302 fixed to the body frame 301. The seat 302 has a seat portion 302a and a backrest portion 302b. The electric wheelchair 300 also has an armrest portion 303 and a footrest portion 304 fixed to the body frame 301.

The electric wheelchair 300 is a four-wheeled wheelchair that includes a bracket portion 311 attached to the front side of the body frame 301, left and right front wheels 320, and left and right rear wheels 330 attached to the bracket portion 311. In the present embodiment, the left and right front wheels 320 serve as steered wheels.

The electric wheelchair 300 includes a housing 340 fixed to the body frame 301. The housing 340 is disposed below the seat portion 302a. The housing 340 houses the electric drive device. The electric drive device includes drive units corresponding to the left and right rear wheels 330, respectively. The drive unit has a configuration similar to that of the drive unit 20 described in each of the above embodiments.

The electric wheelchair 300 is equipped with an operation unit 350 that is operated by the user. The operation unit 350 is fixed to the armrest portion 303. In the present embodiment, the operation unit 350 is a joystick that extends upward. The operation unit 350 is a member that instructs the electric wheelchair 300 to move forward, backward, or turn. The driving speed of the electric wheelchair 300 is, for example, 10 km/h or less.

The electric drive device of the present embodiment has the same configuration as the above-described embodiments, and includes the host ECU. For example, when the host ECU determines that the electric wheelchair 300 has been instructed to turn based on an input signal from the operation unit 350, it transmits a command value for the control amount of the motor 30 (e.g., the rotational speed of the rotor 31) to each drive unit. This command value causes the left and right rear wheels 330 to rotate in the same direction, and the rotational speed of the rear wheel 330 in the instructed turning direction is made slower than the rotational speed of the remaining rear wheel 330. For example, when a right turn is instructed, the command rotation speed of the right rear wheel 330 is set to be lower than the command rotation speed of the left rear wheel 330. The host ECU can also send command values to each drive unit to rotate the left and right rear wheels 330 in opposite directions. In this case, the electric wheelchair 300 performs the extra-pivot turn.

In the present embodiment as well, the driving controls shown in FIGS. 6, 8 and 10 can be applied. For example, when the driving control of FIG. 10 is applied, the processing of step S32 is performed, so that the electric wheelchair 300 can be easily pushed by hand when an abnormality occurs in the system device. This makes it possible to provide a highly convenient electric wheelchair 300.

### Fifth Embodiment

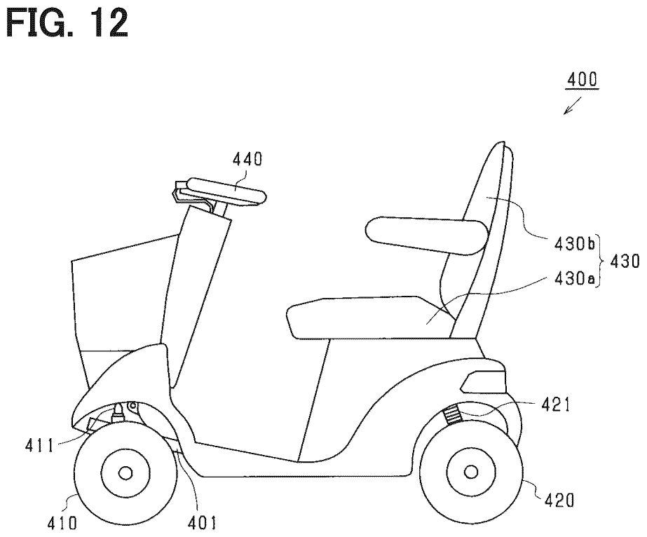

A fifth embodiment will be described below with reference to the drawings mainly in terms of differences from the fourth embodiment. As shown in FIG. 12, the small mobility of the present embodiment is a senior car 400 as a small electric vehicle. The user of the senior car 400 is, for example, an elderly person. The driving speed of the senior car 400 is, for example, 10 km/h or less.

The senior car 400 has a body frame 401. Left and right front wheels 410 are disposed on the front side of the body frame 401. Left and right rear wheels 420 are disposed on the rear side of the body frame 401. A handle unit 440 serving as an operating part for steering the senior car 400 is disposed above the front wheel 410. The front wheel 410 is attached to the body frame 401 via an axle and a suspension 411 (not shown). The rear wheel 420 is attached to the body frame 401 via an axle and a suspension 421 (not shown). In the present embodiment, the left and right front wheels 410 serve as steered wheels, and the left and right rear wheels 420 serve as driving wheels that are rotationally driven by a drive unit, which will be described later.

The senior car 400 includes a seat 430, which has a seat portion 430a and a backrest portion 430b.

The senior car 400 is equipped with a drive unit fixed to the body frame 401.

The senior car 400 is equipped with an electric drive unit. The electric drive device includes drive units corresponding to the left and right front wheels 410 and the left and right rear wheels 420, respectively. The drive unit has a configuration similar to that of the drive unit 20 described in each of the above embodiments. In addition, drive units may be provided corresponding only to the left and right front wheels 410 or only to the left and right rear wheels 420.

The electric drive device of the present embodiment has the same configuration as the above-described embodiments, and includes the host ECU. The host ECU transmits command values to each drive unit, similarly to the third embodiment. This allows the senior car 400 to drive or make turns, as in the third embodiment.

In the present embodiment as well, the driving controls shown in FIGS. 6, 8 and 10 can be applied. For example, when the driving control of FIG. 10 is applied, the processing of step S32 is performed, so that senior car 400 can be easily pushed by hand when an abnormality occurs in the system device. This makes it possible to provide a highly convenient senior car 400.

### Other Embodiments

The above embodiments may be changed and carried out as follows.

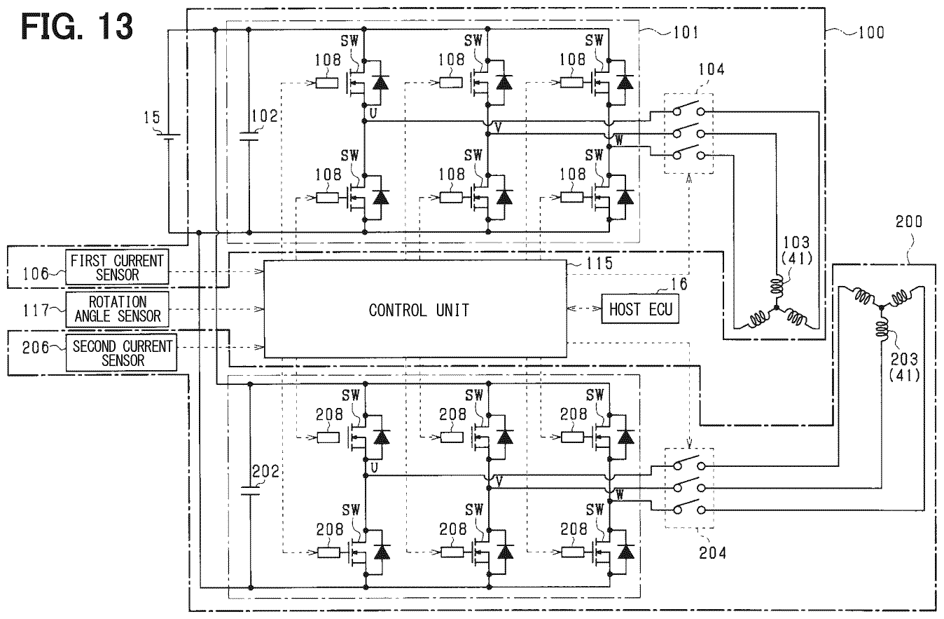

The electrical configuration of the drive unit 20 is not limited to the configuration shown in FIG. 5, and may be, for example, the configuration shown in FIG. 13. In the configuration shown in FIG. 13, the first system device 100 and the second system device 200 share a common control unit 115, and also share a common rotation angle sensor 117 that detects the rotation angle position (electrical angle) of the rotor 31. The power source for the first inverter 101 and the second inverter 201 is the power storage unit 15, and a common power source is used.

The drive unit 20 does not have to be provided with the host ECU 16. In this case, for example, one of the first control unit 105 and the second control unit 205 may be configured to function as a master and the other as a slave.

Each drive unit 20 may be provided with three or more system devices.

In the first to third embodiments, the number of drive wheels of the automated guided vehicle is not limited to six.

The motor is not limited to an inner rotor type, but may be an outer rotor type.

The small-sized mobility vehicle is not limited to those exemplified in the above embodiments, and may be, for example, an electric bicycle or an electric kick scooter. Furthermore, the small mobility vehicle may be one in which crawlers suitable for running on rough terrain are attached to the drive wheels.

The control units and methods thereof described in the present disclosure may be implemented by a dedicated computer including a processor programmed to execute one or more functions embodied by a computer program and a memory. Alternatively, the control units and the methods thereof described in the present disclosure may be implemented by a dedicated computer including a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

Although the present disclosure has been described in accordance with the examples, it is understood that the present disclosure is not limited to such examples or structures. The present disclosure encompasses various modifications and variations within the scope of equivalents. In addition, while the various combinations and configurations, which are preferred, other combinations and configurations, including more, less or only a single element, are also within the spirit and scope of the present disclosure.

What is claimed is:

1. An electric drive device for driving a vehicle, comprising:
a drive unit configured to rotate drive wheels of the vehicle, wherein
the drive unit has
a plurality of system devices,
a rotor constituting a motor and being common to each of the system devices, and
a housing having a long tubular shape in a direction in which a shaft (32) of the rotor extends, and accommodating each of the system devices and the rotor in a tubular space,
each of the system devices has
a stator winding constituting the motor, and
an inverter electrically connected to the stator winding,
the drive unit has a control unit that performs switching control of each of inverters to rotate the rotor for rotating the drive wheels.

2. The electric drive device according to claim 1, wherein
the vehicle includes a pair of left and right drive wheels arranged in a vehicle width direction, and
the drive units are provided individually corresponding to the respective drive wheels,
the control unit,
when it is determined that an abnormality has occurred in any of the system devices in a right unit, which is the drive unit that rotates a right drive wheel, performs a switching control of the inverters of the system devices of the right unit that are not experiencing an abnormality, and a switching of the inverters of the system devices of a left unit, which is the drive unit that rotates a left drive wheel and continues the driving of the vehicle, and
when it is determined that an abnormality has occurred in any of the system devices of the left unit, performs a switching control of the inverter of the system device of the left unit that is not experiencing an abnormality and the switching of the inverter of the system device of the right unit and continues the driving of the vehicle.

3. The electric drive device according to claim 2, wherein
the control unit,
when it is determined that an abnormality has occurred in any of the system devices in the right unit, performs a switching control of the inverter of the system device in which no abnormality has occurred among the system devices in the right unit and a switching control of the inverter of each system device in the left unit, so as to reduce an output torque of the motor of the left unit to the output torque of the motor of the right unit, and continues the driving of the vehicle, and
when it is determined that an abnormality has occurred in any of the system devices in the left unit, performs a switching control of the inverter of the system device in which no abnormality has occurred among the system devices in the left unit and a switching control of the inverter of each system device in the right unit, so as to reduce the output torque of the motor of the right unit to the output torque of the motor of the left unit, and continues the driving of the vehicle.

4. The electric drive device according to claim 2, wherein
the vehicle includes a plurality of pairs of left and right drive wheels arranged in a vehicle width direction,
the control unit,
when it is determined that an abnormality has occurred in any of the system devices of each of the right units, performs a switching control of the inverter of the system device of each of the right units that is not experiencing an abnormality and the switching of the inverter of the system device of each of the left units and continues the driving of the vehicle, and
when it is determined that an abnormality has occurred in any of the system devices of each of the left units, performs a switching control of the inverter of the system device of each of the left units that is not experiencing an abnormality and the switching of the inverter of the system device of each of the right units and continues the driving of the vehicle.

5. The electric drive device according to claim 4, wherein
the control unit,
when it is determined that an abnormality has occurred in any of the system devices in each of the right units, performs a switching control of the inverters of the system device in which no abnormality has occurred among each system device in each of the right units and a switching control of the inverters of each system device in each of the left units, so as to reduce an output torque of the motor of the left unit that is arranged in the vehicle width direction with the right unit having the system device in which an abnormality has occurred to an output torque of the motor of the right unit having the system device in which an abnormality has occurred, and continues the driving of the vehicle, and
when it is determined that an abnormality has occurred in any of the system devices in each of the left units, performs a switching control of the inverters of the system device in which no abnormality has occurred among each system device in each of the left units and a switching control of the inverters of each system device in each of the right units, so as to reduce the output torque of the motor of the right unit that is aligned in the vehicle width direction with the left unit having the system device in which the abnormality has occurred to the output torque of the motor of the left unit having the system device in which the abnormality has occurred, and continues the driving of the vehicle.

6. The electric drive device according to claim 4, wherein
the control unit,
when it is determined that an abnormality has occurred in any of the system devices in each of the right units, performs a switching control of the inverter of at least one system device in which no abnormality has occurred among the system devices in each of the right units and a switching control of the inverter of at least one system device in each of the left units, so as to reduce a total output torque of the motors of each of the left units to a total output torque of the motors of each of the right units, and continues the driving of the vehicle, and
when it is determined that an abnormality has occurred in any of the system devices in each of the left units, performs a switching control of the inverter of at least one system device in which no abnormality has occurred among the system devices in each of the left units and a switching control of the inverter of at least one system device in each of the right units, so as to reduce a total output torque of the motors of each of the right units to a total output torque of the motors of each of the left units, and continues the driving of the vehicle.

7. The electric drive device according to claim 2, wherein
the vehicle is
an automated guided vehicle for use in a factory, or
a small electric vehicle including a front wheel, a rear wheel and a user seat, in which at least one of the front wheel and the rear wheel is a driving wheel,
each of the system devices has a cutoff switch that electrically connects the stator winding and the inverter when turned on and electrically cuts off the stator winding and the inverter when turned off, and
when it is determined that an abnormality has occurred in any of the system devices in each of the drive units, the control unit turns off the cutoff switch of the system device in which the abnormality has occurred.

8. The electric drive device according to claim 2, wherein
the vehicle is
an automated guided vehicle for use in a factory, or
a small electric vehicle including a front wheel, a rear wheel and a user seat, in which at least one of the front wheel and the rear wheel is a driving wheel,
each of the system devices has a cutoff switch that electrically connects the stator winding and the inverter when turned on and electrically cuts off the stator winding and the inverter when turned off, and
when the control unit determines that an abnormality has occurred in any of the system devices in each of the drive units, the control unit turns off the cutoff switches of all of the system devices that constitute each of the drive units.

9. The electric drive device according to claim 1, wherein
the vehicle is
an automated guided vehicle for use in a factory, or
a small electric vehicle including a front wheel, a rear wheel and a user seat, in which at least one of the front wheel and the rear wheel is a driving wheel,
each of the system devices has a cutoff switch that electrically connects the stator winding and the inverter when turned on and electrically cuts off the stator winding and the inverter when turned off, and
when it is determined that an abnormality has occurred in any of the system devices, the control unit turns off the cutoff switches of all of the system devices.

10. An electric drive device for driving a vehicle, comprising:
a drive unit configured to rotate drive wheels of the vehicle, wherein
the drive unit has
a plurality of system devices,
a rotor constituting a motor and being common to each of the system devices, and
a housing having a long tubular shape in a direction in which a shaft (32) of the rotor extends, and accommodating each of the system devices and the rotor in a tubular space,
each of the system devices has
a stator winding constituting the motor, and
an inverter electrically connected to the stator winding,
the drive unit has a control unit including a computer having a processor and a memory that stores instructions configured to, when executed by the processor, cause the processor to
perform a switching control of each of inverters to rotate the rotor for rotating the drive wheels.

11. The electric drive device according to claim 10, wherein
the vehicle includes a pair of left and right drive wheels arranged in a vehicle width direction, and
the drive units are provided individually corresponding to the respective drive wheels,
the control unit causes the processor to,
when it is determined that an abnormality has occurred in any of the system devices in a right unit, which is the drive unit that rotates a right drive wheel, perform a switching control of the inverters of the system devices of the right unit that are not experiencing an abnormality, and a switching of the inverters of the system devices of a left unit, which is the drive unit that rotates a left drive wheel and continue the driving of the vehicle, and
when it is determined that an abnormality has occurred in any of the system devices of the left unit, perform a switching control of the inverter of the system device of the left unit that is not experiencing an abnormality and the switching of the inverter of the system device of the right unit and continue the driving of the vehicle.

12. The electric drive device according to claim 11, wherein
the control unit causes the processor to,
when it is determined that an abnormality has occurred in any of the system devices in the right unit, perform a switching control of the inverter of the system device in which no abnormality has occurred among the system devices in the right unit and a switching control of the inverter of each system device in the left unit, so as to reduce an output torque of the motor of the left unit to the output torque of the motor of the right unit, and continue the driving of the vehicle, and
when it is determined that an abnormality has occurred in any of the system devices in the left unit, perform a switching control of the inverter of the system device in which no abnormality has occurred among the system devices in the left unit and a switching control of the inverter of each system device in the right unit, so as to reduce the output torque of the motor of the right unit to the output torque of the motor of the left unit, and continues the driving of the vehicle.

13. The electric drive device according to claim 11, wherein
the vehicle includes a plurality of pairs of left and right drive wheels arranged in a vehicle width direction,
the control unit causes the processor to,
when it is determined that an abnormality has occurred in any of the system devices of each of the right units, perform a switching control of the inverter of the system device of each of the right units that is not experiencing an abnormality and the switching of the inverter of the system device of each of the left units and continue the driving of the vehicle, and
when it is determined that an abnormality has occurred in any of the system devices of each of the left units, perform a switching control of the inverter of the system device of each of the left units that is not experiencing an abnormality and the switching of the inverter of the system device of each of the right units and continue the driving of the vehicle.

14. The electric drive device according to claim 13, wherein
the control unit causes the processor to,
when it is determined that an abnormality has occurred in any of the system devices in each of the right units, perform a switching control of the inverters of the system device in which no abnormality has occurred among each system device in each of the right units and a switching control of the inverters of each system device in each of the left units, so as to reduce an output torque of the motor of the left unit that is arranged in the vehicle width direction with the right unit having the system device in which an abnormality has occurred to an output torque of the motor of the right unit having the system device in which an abnormality has occurred and continue the driving of the vehicle, and
when it is determined that an abnormality has occurred in any of the system devices in each of the left units, perform a switching control of the inverters of the system device in which no abnormality has occurred among each system device in each of the left units and a switching control of the inverters of each system device in each of the right units, so as to reduce the output torque of the motor of the right unit that is aligned in the vehicle width direction with the left unit having the system device in which the abnormality has occurred to the output torque of the motor of the left unit having the system device in which the abnormality has occurred and continue the driving of the vehicle.

15. The electric drive device according to claim 13, wherein
the control unit causes the processor to,
when it is determined that an abnormality has occurred in any of the system devices in each of the right units, perform a switching control of the inverter of at least one system device in which no abnormality has occurred among the system devices in each of the right units and a switching control of the inverter of at least one system device in each of the left units, so as to reduce a total output torque of the motors of each of the left units to a total output torque of the motors of each of the right units, and continue the driving of the vehicle, and
when it is determined that an abnormality has occurred in any of the system devices in each of the left units, perform a switching control of the inverter of at least one system device in which no abnormality has occurred among the system devices in each of the left units and a switching control of the inverter of at least one system device in each of the right units, so as to reduce a total output torque of the motors of each of the right units to a total output torque of the motors of each of the left units, and continue the driving of the vehicle.
